(19) United States
(12) Patent Application Publication
(10) Pub. No.: US 2024/0186038 A1
(43) Pub. Date: Jun. 6, 2024

(54) SOFT MAGNETIC POWDER, METAL POWDER, DUST CORE, MAGNETIC ELEMENT, AND ELECTRONIC DEVICE

(71) Applicant: SEIKO EPSON CORPORATION, TOKYO (JP)

(72) Inventor: Mayu WATANABE, HACHINOHE-SHI (JP)

(21) Appl. No.: 18/491,915

(22) Filed: Oct. 23, 2023

(30) Foreign Application Priority Data
Oct. 25, 2022 (JP) 2022-170764

(51) Int. Cl. H01F 1/147; B22F 1/142; B22F 3/02; B22F 3/24; B22F 5/10; B22F 9/08; C22C 38/02; C22C 38/20; C22C 38/26; C22C 38/32; C22C 38/34

(52) U.S. Cl. CPC H01F 1/14775; B22F 1/142; B22F 3/02; B22F 3/24; B22F 5/106; B22F 9/082; C22C 38/02; C22C 38/20; C22C 38/26; C22C 38/32; C22C 38/34; H01F 27/255

(57) ABSTRACT

A soft magnetic powder contains a composition represented by a composition formula FeₓCuₐNb_{b}(Si_{1-y}(B_{1-z}Cr_{z})_{y})_{100-x-a-b} in terms of atomic ratio [in which a, b, x, y, and z satisfy 0.3≤a≤2.0, 2.0≤b≤4.0, 75.5≤x≤79.5, 0.55≤y≤0.91, and 0.015≤z≤0.185], and impurities. A crystallite diameter measured by X-ray diffractometry is 6.0 nm or more and 13.0 nm or less.

The present application is based on, and claims priority from JP Application Serial Number 2022-170764, filed Oct. 25, 2022, the disclosure of which is hereby incorporated by reference herein in its entirety.

### BACKGROUND

### 1. Technical Field

The present disclosure relates to a soft magnetic powder, a metal powder, a dust core, a magnetic element, and an electronic device.

### 2. Related Art

In various mobile devices including a magnetic element, in order to reduce a size and achieve a high output, it is necessary to cope with a high frequency and a high current of a conversion frequency of a switching power supply. Accordingly, a magnetic element used for a switching power supply is also required to have a small size and a high output.

JP-A-2018-53319 discloses a soft magnetic powder having a composition represented by Fe_{100-a-b-c-d-e-f-g-h}CuₐSi_{b}B_{c}M_{d}M′ₑX_{f}Al_{g}Tiₕ (atomic %), and containing a crystalline structure having a grain diameter of 1 nm or more and 30 nm or less in an amount of 40 vol % or more. JP-A-2018-53319 also discloses that in the composition formula, M is Nb and M′ is Cr. Such a soft magnetic powder can implement a magnetic element having a high magnetic permeability and a small size.

However, the soft magnetic powder described in JP-A-2018-53319 is easily oxidized depending on the composition, and has a problem that a density during molding cannot be sufficiently increased. The density of the molded body influences the magnetic permeability of a magnetic element including a dust core. Therefore, it is an object of the present disclosure to provide a soft magnetic powder with which a molded body having excellent oxidation resistance, a high density, and a high magnetic permeability can be produced.

### SUMMARY

A soft magnetic powder according to an application example of the present disclosure contains: a composition represented by a composition formula FeₓCuₐNb_{b}(Si_{1-y}(B_{1-z}Cr_{z})_{y})_{100-x-a-b} in terms of atomic ratio,
a, b, x, y, and z satisfying
0.3≤a≤2.0,
2.0≤b≤4.0,
75.5≤x≤79.5,
0.55≤y≤0.91, and
0.015≤z≤0.185; and impurities, in which
a crystallite diameter measured by X-ray diffractometry is 6.0 nm or more and 13.0 nm or less.

A metal powder according to an application example of the present disclosure is a metal powder crystallized by being subjected to a heat treatment, and contains: a composition represented by a composition formula FeₓCuₐNb_{b}(Si_{1-y}(B_{1-z}Cr_{z})_{y})_{100-x-a-b} in terms of atomic ratio,
a, b, x, y, and z satisfying
0.3≤a≤2.0,
2.0≤b≤4.0,
75.5≤x≤79.5,
0.55≤y≤0.91, and
0.015≤z≤0.185; and impurities, in which
a DSC curve obtained by differential scanning calorimetry has a first exothermic peak and a second exothermic peak located on a higher temperature side than the first exothermic peak, and a temperature difference between the first exothermic peak and the second exothermic peak is 125° C. or higher and 180° C. or lower.

A dust core according to an application example of the present disclosure contains: the soft magnetic powder according to the application example of the present disclosure.

A magnetic element according to an application example of the present disclosure includes: the dust core according to the application example of the present disclosure.

An electronic device according to an application example of the present disclosure includes: the magnetic element according to the application example of the present disclosure.

### BRIEF DESCRIPTION OF THE DRAWINGS

FIG. 1 is an example of a DSC curve acquired from a metal powder according to an embodiment.

FIG. 2 is a plan view schematically showing a toroidal type coil component.

FIG. 3 is a transparent perspective view schematically showing a closed magnetic circuit type coil component.

FIG. 4 is a perspective view showing a configuration of a mobile personal computer which is an electronic device including a magnetic element according to the embodiment.

FIG. 5 is a plan view showing a configuration of a smartphone which is an electronic device including the magnetic element according to the embodiment.

FIG. 6 is a perspective view showing a configuration of a digital still camera which is an electronic device including the magnetic element according to the embodiment.

### DESCRIPTION OF EMBODIMENTS

Hereinafter, a soft magnetic powder, a metal powder, a dust core, a magnetic element, and an electronic device according to the present disclosure will be described in detail based on a preferred embodiment shown in the accompanying drawings.

### 1. Soft Magnetic Powder

The soft magnetic powder according to the embodiment is a metal powder which exhibits soft magnetism. Such a soft magnetic powder can be applied to any application, and for example, is used for producing various green compacts such as dust cores and electromagnetic wave absorbers in which particles are bound to each other via a binder.

The soft magnetic powder according to the embodiment contains a composition represented by a composition formula FeₓCuₐNb_{b}(Si_{1-y}(B_{1-z}Cr_{z})_{y})_{100-x-a-b} in terms of atomic ratio,
[in which a, b, x, y, and z satisfy
0.3≤a≤2.0,
2.0≤b≤4.0,
75.5≤x≤79.5,
0.55≤y≤0.91, and
0.015≤z≤0.185], and impurities.

The soft magnetic powder according to the embodiment has a crystallite diameter of 6.0 nm or more and 13.0 nm or less as measured by X-ray diffractometry.

In such a soft magnetic powder, Cr is added, and an addition amount thereof is optimized. Accordingly, oxidation resistance of the soft magnetic powder can be improved. As a result, when the soft magnetic powder is compacted, it is possible to prevent a decrease in density of the green compact due to an oxide. In the soft magnetic powder, the crystallite diameter can be controlled so as not to be too small or too large. As a result, a magnetic permeability can be increased while preventing an increase in coercive force of the soft magnetic powder.

The soft magnetic powder according to the embodiment will be described in detail below.

### 1.1. Composition

Fe (iron) greatly influences basic magnetic properties and mechanical properties of the soft magnetic powder according to the embodiment.

A content x of Fe is 75.5 atomic % or more and 79.5 atomic % or less, preferably 76.0 atomic % or more and 78.5 atomic % or less, and more preferably 76.5 atomic % or more and 78.0 atomic % or less. When the content x of Fe goes below the above lower limit value, a saturation magnetic flux density of the soft magnetic powder decreases. On the other hand, when the content x of Fe exceeds the above upper limit value, an amorphous structure cannot be stably formed during production of the soft magnetic powder, and thus the crystallite diameter becomes too large and the coercive force increases.

Cu (copper) tends to be separated from Fe when the soft magnetic powder according to the embodiment is produced from a raw material. Therefore, since Cu is contained, the composition fluctuates, and a region that is easily crystallized is partially generated in a particle. As a result, precipitation of a Fe phase having a body centered cubic lattice, which is relatively easily crystallized, is promoted, and crystal grains having the above crystallite diameter are easily formed.

A content a of Cu is 0.3 atomic % or more and 2.0 atomic % or less, preferably 0.5 atomic % or more and 1.5 atomic % or less, and more preferably 0.7 atomic % or more and 1.3 atomic % or less. When the content a of Cu goes below the above lower limit value, miniaturization of the crystal grains is impaired, and the crystal grains having the crystallite diameter in the above range cannot be formed. On the other hand, when the content a of Cu exceeds the above upper limit value, the mechanical properties of the soft magnetic powder are deteriorated, resulting in embrittlement.

Nb (niobium) together with Cu contributes to the miniaturization of the crystal grain when a heat treatment is applied in a state where a large amount of amorphous structure is contained. Therefore, the crystal grains having the above crystallite diameter are easily formed.

A content b of Nb is 2.0 atomic % or more and 4.0 atomic % or less, preferably 2.5 atomic % or more and 3.5 atomic % or less, and more preferably 2.7 atomic % or more and 3.3 atomic % or less. When the content b of Nb goes below the above lower limit value, the miniaturization of the crystal grains is impaired, and the crystal grains having the crystallite diameter in the above range cannot be formed. On the other hand, when the content b of Nb exceeds the above upper limit value, the mechanical properties of the soft magnetic powder are deteriorated, resulting in embrittlement. In addition, the magnetic permeability of the soft magnetic powder decreases.

Si (silicon) promotes amorphization when the soft magnetic powder according to the embodiment is produced from a raw material. Therefore, when producing the soft magnetic powder according to the embodiment, first, a homogeneous amorphous structure is formed, and thereafter, the amorphous structure is crystallized, whereby a crystal grain having a more uniform crystallite diameter is easily formed. The uniform crystallite diameter contributes to averaging of magnetocrystalline anisotropy in each crystal grain, and therefore, the coercive force can be reduced, and the magnetic permeability can be increased, contributing to improvement in soft magnetism.

B (boron) promotes the amorphization when producing the soft magnetic powder according to the embodiment from a raw material. Therefore, when producing the soft magnetic powder according to the embodiment, first, a homogeneous amorphous structure is formed, and thereafter, the amorphous structure is crystallized, whereby a crystal grain having a more uniform crystallite diameter is easily formed. As a result, the coercive force can be reduced, the magnetic permeability can be increased, and the soft magnetism can be improved. Further, by using Si and B in combination, based on a difference in atomic radius between Si and B, it is possible to synergistically promote the amorphization.

Cr (chromium) improves the oxidation resistance of the soft magnetic powder. Accordingly, when the soft magnetic powder is compacted, it is possible to prevent the decrease in density of the green compact due to an oxide. As a result, the magnetic permeability and the saturation magnetic flux density measured in a state of a molded body can be increased. In addition, by optimizing a content of Cr, the crystallite diameter can be controlled so as not to be too small or too large in the soft magnetic powder. As a result, the magnetic permeability can be increased while preventing an increase in coercive force of the soft magnetic powder.

Here, a total content (Si+B+Cr) of Si, B, and Cr is set to 1, and a ratio of a total content (B+Cr) of B and Cr to the total content (Si+B+Cr) is set to y.

This y satisfies 0.55≤y≤0.91, preferably satisfies 0.60≤y≤0.90, and more preferably satisfies 0.65≤y≤0.80. Accordingly, a quantitative balance of Si with B and Cr can be achieved. As a result, both the oxidation resistance and the magnetic permeability of the soft magnetic powder can be improved in a balanced manner.

When y goes below the above lower limit value, the oxidation resistance decreases, the crystallite diameter becomes too small, and the magnetic permeability decreases. On the other hand, when y exceeds the above upper limit value, the crystallite diameter becomes too large, and the coercive force increases.

A ratio of the content of Cr to the total content (B+Cr) is defined as z.

This z satisfies 0.015≤z≤0.185, preferably satisfies 0.030≤z≤0.150, and more preferably satisfies 0.045≤z≤0.120. Accordingly, a quantitative balance of B with Cr can be achieved. As a result, both the oxidation resistance and the magnetic permeability of the soft magnetic powder can be improved in a balanced manner.

When z goes below the above lower limit value, the oxidation resistance decreases, the crystallite diameter becomes too small, and the magnetic permeability decreases. On the other hand, when z exceeds the above upper limit value, the crystallite diameter becomes too large, and the coercive force increases.

A content of Si is preferably 1.5 atomic % or more and 14.0 atomic % or less, more preferably 3.0 atomic % or more and 10.0 atomic % or less, and still more preferably 4.0 atomic % or more and 8.0 atomic % or less. Accordingly, the magnetic permeability of the soft magnetic powder can be further increased and the coercive force can be further reduced.

A content of B is preferably 5.0 atomic % or more and 17.0 atomic % or less, more preferably 7.0 atomic % or more and 16.0 atomic % or less, and still more preferably 9.0 atomic % or more and 13.5 atomic % or less. Accordingly, the magnetic permeability of the soft magnetic powder can be further increased and the coercive force can be further reduced.

The content of Cr is preferably 0.3 atomic % or more and 2.7 atomic % or less, more preferably 0.5 atomic % or more and 2.2 atomic % or less, and still more preferably 0.8 atomic % or more and 1.8 atomic % or less. Accordingly, the oxidation resistance of the soft magnetic powder can be further improved, and generation of oxides can be further reduced. As a result, it is possible to prevent the decrease in density of the green compact due to an oxide, and to further increase the magnetic permeability and the saturation magnetic flux density of the molded body. In addition, the crystallite diameter of the crystal grains contained in each particle can be appropriately controlled, and the balance between a low coercive force and a high magnetic permeability can be further optimized.

The soft magnetic powder according to the embodiment may contain, in addition to the composition represented by the above composition formula FeₓCuₐNb_{b}(Si_{1-y}(B_{1-z}Cr_{z})_{y})_{100-x-a-b}, an impurity. Examples of the impurity include all elements other than those described above, and a total content of impurities is preferably 0.50 atomic % or less. Within this range, the above effect is less likely to be inhibited even when impurities are mixed, and thus the impurities are allowed to be contained.

A content of each element contained in the impurities is preferably 0.05 atomic % or less. Within this range, impurities do not easily inhibit the above effect, and thus are allowed to be contained.

Among the impurities, particularly, a content of oxygen is preferably 1500 ppm or less, and more preferably 800 ppm or less. When the content of oxygen is within the above range, the generation of oxides that cause the decrease in density of the molded body can be particularly reduced.

The soft magnetic powder according to the embodiment is described above, and the composition and the impurities are identified by the following analysis method.

Examples of the analysis method include iron and steel-atomic absorption spectrometry defined in JIS G 1257:2000, iron and steel-ICP atomic emission spectrometry defined in JIS G 1258:2007, iron and steel-spark discharge atomic emission spectrometry defined in JIS G 1253:2002, iron and steel-X-ray fluorescence spectrometry defined in JIS G 1256:1997, and gravimetric, titration and absorption spectrometric methods defined in JIS G 1211 to JIS G 1237.

Specifically, for example, an optical emission spectrometer for solids, in particular, a spark discharge emission spectrometer, model: SPECTROLAB, type: LAVMB08A manufactured by SPECTRO Analytical Instruments GmbH or an ICP device (model: CIROS120) manufactured by Rigaku Corporation can be used.

In particular, when C (carbon) and S (sulfur) are to be identified, a combustion in a current of oxygen (combustion in high frequency induction furnace)-infrared absorption methoddefined in JIS G 1211:2011 is also used. Specifically, examples include a carbon-sulfur analyzer CS-200 manufactured by LECO Corporation.

In particular, when N (nitrogen) and O (oxygen) are to be identified, methods for determination of nitrogen content for an iron and steel defined in JIS G 1228:1997 and general rules for determination of oxygen in metallic materials defined in JIS Z 2613:2006 are also used. Specifically, examples include an oxygen/nitrogen elemental analyzer TC-300/EF-300 manufactured by LECO Corporation and an oxygen/nitrogen/hydrogen elemental analyzer ONH836 manufactured by LECO Corporation.

### 1.2. Crystallite Diameter

The soft magnetic powder according to the embodiment has a crystallite diameter of 6.0 nm or more and 13.0 nm or less as measured by X-ray diffractometry. When the crystallite diameter is within such a range, the crystallite diameter of the soft magnetic powder is optimized, and thus the magnetic permeability of the soft magnetic powder can be increased. In addition, the magnetocrystalline anisotropy in each crystal grain is easily averaged, and a soft magnetic powder having a low coercive force is obtained. Further, since the magnetic permeability is increased, saturation is less likely to occur even under a high current, and thus the saturation magnetic flux density of the soft magnetic powder is easily increased.

The crystallite diameter of the soft magnetic powder is preferably 7.0 nm or more and 12.0 nm or less, and more preferably 8.0 nm or more and 11.0 nm or less.

The measurement of the crystallite diameter by the X-ray diffractometry is performed by a method in which an X-ray diffraction pattern is acquired for each of the soft magnetic powder and a standard sample, a diffraction line width derived from Fe is estimated, and then the crystallite diameter is calculated by a Scherrer method. The X-ray diffraction pattern acquired for the standard sample is used to estimate a diffraction line width derived from an apparatus. The crystallite diameter calculated from the soft magnetic powder (test sample) can be corrected based on the diffraction line width.

Particles constituting the soft magnetic powder according to the embodiment contain crystal grains having the above crystallite diameter, and may further contain an amorphous structure. Since the crystal grains and the amorphous structure coexist, magnetostriction of the soft magnetic powder can be further reduced. As a result, a soft magnetic powder having a particularly high magnetic permeability is obtained. In addition, a soft magnetic powder whose magnetization is easily controlled is also obtained.

### 1.3. Various Properties

An average particle diameter of the soft magnetic powder according to the embodiment is not particularly limited, and is preferably 1 μm or more and 50 μm or less, more preferably 10 μm or more and 45 μm or less, and still more preferably 20 μm or more and 40 μm or less. By using the soft magnetic powder having such an average particle diameter, a path through which an eddy current flows can be shortened, and thus, a magnetic element capable of sufficiently reducing an eddy current loss generated in the particles of the soft magnetic powder can be produced. In addition, a filling rate of the soft magnetic powder in the green compact can be increased, and the magnetic permeability and the saturation magnetic flux density of the dust core can be increased.

When the average particle diameter of the soft magnetic powder is 10 μm or more, by mixing the soft magnetic powder with a soft magnetic powder having an average particle diameter smaller than that of the soft magnetic powder according to the embodiment, a higher molded body density can be implemented. Accordingly, it is easier to further increase the saturation magnetic flux density and the magnetic permeability of the dust core.

The average particle diameter of the soft magnetic powder refers to a particle diameter D50 where a cumulative frequency is 50% from a small-diameter side in a cumulative particle size distribution on a volume basis of the soft magnetic powder acquired using a laser diffraction type particle size distribution measuring apparatus.

When the average particle diameter of the soft magnetic powders goes below the above lower limit value, the soft magnetic powder is too fine, and thus filling properties of the soft magnetic powder may easily decrease. Accordingly, a molding density of the dust core is reduced, and thus the magnetic permeability and the saturation magnetic flux density of the dust core may decrease depending on the composition and mechanical properties of the soft magnetic powder. On the other hand, when the average particle diameter of the soft magnetic powder exceeds the above upper limit value, depending on the composition and the mechanical properties of the soft magnetic powder, the eddy current loss generated in the particles cannot be sufficiently reduced, and an iron loss of the magnetic element may increase.

The coercive force of the soft magnetic powder according to the embodiment is not particularly limited, and is preferably less than 2.00 Oe (less than 160 A/m), and more preferably 0.10 Oe or more and 1.67 Oe or less (39.9 A/m or more and 133 A/m or less). By using the soft magnetic powder having such a small coercive force, it is possible to produce a magnetic element capable of sufficiently reducing a hysteresis loss even under a high frequency.

The coercive force of the soft magnetic powder can be measured, for example, by a vibrating sample magnetometer such as TM-VSM1230-MHHL manufactured by TAMAKAWA CO., LTD.

When the soft magnetic powder according to the embodiment is made into a molded body, the magnetic permeability thereof is preferably 24.0 or more and more preferably 25.0 or more at a measurement frequency of 1 MHz. Such a soft magnetic powder contributes to implementation of a magnetic element having excellent DC superimposition properties, high electromagnetic conversion efficiency at a high frequency, and a small size. The magnetic permeability is measured in a state where an epoxy resin is added to the soft magnetic powder at a ratio of 2 mass %, the soft magnetic powder is compacted at a molding pressure of 294 MPa (3 t/cm²) to a ring shape having an outer diameter of 14 mm, an inner diameter of 8 mm, and a thickness of 3 mm, and then a conductive wire having a wire diameter of 0.6 mm is wound seven times around the molded body having such a ring shape. For the measurement of the magnetic permeability, for example, an impedance analyzer such as 4194A manufactured by Agilent Technologies, Inc. is used. Then, the measurement frequency is set to 1 MHz, and an effective magnetic permeability obtained based on a self-inductance of a closed magnetic core coil is taken as a measurement value.

The saturation magnetic flux density of the soft magnetic powder according to the embodiment is preferably 1.25 T or more, and more preferably 1.30 T or more. Accordingly, the magnetic element in which the saturation is less likely to occur even under a high current is obtained.

The saturation magnetic flux density of the soft magnetic powder is measured, for example, by the following method.

First, a true specific gravity p of the soft magnetic powder is measured by a full-automatic gas substitution type densitometer AccuPyc 1330 manufactured by Micromeritics Instrument Corporation. Next, a maximum magnetization Mm of the soft magnetic powder is measured by a vibrating sample magnetometer, VSM system, TM-VSM1230-MHHL manufactured by TAMAKAWA CO., LTD. Then, a saturation magnetic flux density Bs is calculated according to the following equation.

Bs=4Π/10000×ρ×Mm

A density of the molded body obtained by mixing the soft magnetic powder according to the embodiment with 2 mass % of an epoxy resin and press-molding the obtained mixture at a pressure of 294 MPa is preferably 4.99 g/cm³ or more, and more preferably 5.01 g/cm³ or more and 5.20 g/cm³ or less. When the density of the molded body is within the above range, an occupancy of oxides in the molded body is sufficiently reduced, and as a result, an occupancy of an alloy can be sufficiently secured. Accordingly, the magnetic permeability and the saturation magnetic flux density of the magnetic element can be further increased.

The soft magnetic powder according to the embodiment may be mixed with another soft magnetic powder or a non-soft magnetic powder, and may be used as a mixed powder for various applications.

### 1.4. Effects of Soft Magnetic Powder According to Embodiment

The soft magnetic powder according to the above embodiment contains a composition represented by a composition formula FeₓCuₐNb_{b}(Si_{1-y}(B_{1-z}Cr_{z})_{y})_{100-x-a-b} in terms of atomic ratio,
[in which a, b, x, y, and z satisfy
0.3≤a≤2.0,
2.0≤b≤4.0,
75.5≤x≤79.5,
0.55≤y≤0.91, and
0.015≤z≤0.185], and impurities.

A crystallite diameter measured by X-ray diffractometry is 6.0 nm or more and 13.0 nm or less.

According to such a configuration, it is possible to obtain a soft magnetic powder with which a molded body having a high density and a high magnetic permeability can be produced since the oxidation resistance is excellent and the crystallite diameter is optimized.

In the soft magnetic powder, a content of Si is preferably 4.0 atomic % or more and 8.0 atomic % or less, a content of B is preferably 9.0 atomic % or more and 13.5 atomic % or less, and a content of Cr is preferably 0.5 atomic % or more and 2.2 atomic % or less. Accordingly, it is possible to obtain a soft magnetic powder with which a molded body having a particularly high magnetic permeability can be produced.

The soft magnetic powder is molded into a ring-shaped molded body having an outer diameter of 14 mm, an inner diameter of 8 mm, and a thickness of 3 mm, and when a magnetic permeability is measured at a measurement frequency of 1 MHz by using a conductive wire having a wire diameter of 0.6 mm wound seven times around the molded body, the magnetic permeability is preferably 24.0 or more.

Accordingly, it is possible to obtain a soft magnetic powder that contributes to implementation of a magnetic element having excellent DC superimposition properties, high electromagnetic conversion efficiency at a high frequency, and a small size.

A content of oxygen in the soft magnetic powder is preferably 1500 ppm or less. Accordingly, the generation of oxides that cause a decrease in density of the molded body can be particularly reduced.

In the soft magnetic powder, when a maximum magnetization measured using a vibrating sample magnetometer is Mm [emu/g] and a true density is ρ [g/cm³], a saturation magnetic flux density Bs [T] obtained by 4Π/10000×ρ×Mm=Bs is preferably 1.25 T or more. Accordingly, it is possible to obtain a soft magnetic powder with which a magnetic element in which saturation is less likely to occur even under a high current can be produced.

A density of a molded body obtained by mixing the soft magnetic powder with 2 mass % of an epoxy resin and press-molding the obtained mixture at a pressure of 294 MPa is preferably 4.99 g/cm³ or more. Accordingly, an occupancy of oxides in the molded body is sufficiently reduced, and as a result, an occupancy of an alloy can be sufficiently secured. Accordingly, the magnetic permeability and the saturation magnetic flux density of the magnetic element can be further increased.

### 2. Method for Producing Soft Magnetic Powder

Next, an example of a method for producing the above soft magnetic powder will be described.

### 2.1. Outline of Production Method

The soft magnetic powder may be a powder produced by any method. Examples of the production method include a pulverization method, in addition to various atomization methods such as a water atomization method, a gas atomization method, and a rotary water atomization method. Among these, the atomization method is preferably used. According to the atomization method, it is possible to efficiently produce a high-quality metal powder having a particle shape closer to a sphere and with less formation of oxides and the like. Therefore, a metal powder having a smaller specific surface area can be produced by the atomization method.

The atomization method is a method for producing a metal powder by causing a molten metal to collide with a liquid or a gas injected at a high speed so as to pulverize and cool the molten metal. In the atomization method, since spheroidization is performed during a process of solidification after the molten metal is pulverized, particles close to a sphere can be produced.

Among these, the water atomization method is a method for producing a metal powder from a molten metal by using a liquid such as water as a cooling liquid, injecting this liquid in an inverted conical shape so as to converge on one point, and causing the molten metal to flow down to the convergence point and to collide with the cooling liquid.

In addition, the rotary water atomization method is a method for producing a metal powder by supplying a cooling liquid along an inner circumferential surface of a cooling tubular body and swirling the cooling liquid along the inner circumferential surface, and at the same time, spraying a liquid or gas jet to the molten metal, and taking the scattered molten metal into the cooling liquid.

Further, the gas atomization method is a method for producing a metal powder from a molten metal by using a gas as a cooling medium, injecting the gas in an inverted conical shape so as to converge on one point, and causing the molten metal to flow down to the convergence point and to collide with the gas.

The particles of the metal powder obtained in the above manner are constituted by an amorphous structure. By subjecting such a metal powder to a crystallization treatment (heat treatment) described later, the above soft magnetic powder is obtained.

The metal powder according to the embodiment is a metal powder based on the premise that the metal powder is subjected to the crystallization treatment, and contains a composition and impurities same as those of the above soft magnetic powder.

For such a metal powder, a differential scanning calorimeter (DSC) curve is obtained by differential scanning calorimetry. A mass of a sample in the differential scanning calorimetry is 20 mg, and a measurement atmosphere is a nitrogen atmosphere.

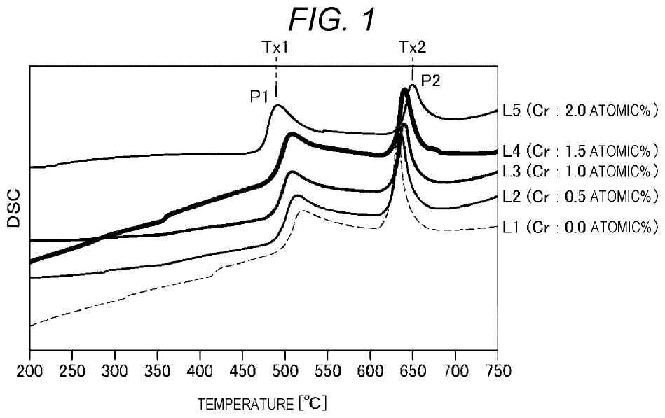

FIG. 1 is an example of the DSC curve acquired from the metal powder according to the embodiment.

DSC curves L1 to L5 shown in FIG. 1 each have a first exothermic peak P1 and a second exothermic peak P2. The second exothermic peak P2 is located on a higher temperature side than the first exothermic peak P1. The DSC curves L1 to L5 are DSC curves obtained from metal powders of Sample Nos. 3, 5, 6, 7, and 8 described later. Specifically, the DSC curves L1, L2, L3, L4, and L5 are obtained from metal powders having a composition in which the content of Cr is 0.0 atomic %, 0.5 atomic %, 1.0 atomic %, 1.5 atomic %, and 2.0 atomic %.

The first exothermic peak P1 is a peak in which a temperature Tx1 at a peak top is in a range of 450° C. or higher and 550° C. or lower. The first exothermic peak P1 is a peak caused by heat generated when the crystal grains of the above soft magnetic powder are generated. Therefore, it can be said that the first exothermic peak P1 is a peak due to crystallization necessary in the production of the soft magnetic powder. By such necessary crystallization, for example, crystal grains having a body centered cubic lattice (Bcc-Fe) structure are generated. Hereinafter, these are also simply referred to as “crystal grains”.

The second exothermic peak P2 is a peak in which a temperature Tx2 at a peak top is in a range of 600° C. or higher and 700° C. or lower. The second exothermic peak P2 is a peak caused by heat generated when a crystal structure different from the crystal grains of the above soft magnetic powder is generated. The crystal structure contains, for example, a Fe—B-based alloy as a main component, and causes the soft magnetism of the soft magnetic powder to deteriorate. Therefore, it can be said that the second exothermic peak P2 is a peak due to a crystal structure unnecessary in the production of the soft magnetic powder. Hereinafter, this is also simply referred to as an “unnecessary crystal structure”.

In the metal powder according to the embodiment, a temperature difference Tx2−Tx1 between the first exothermic peak P1 and the second exothermic peak P2 is 125° C. or higher and 180° C. or lower. According to such a configuration, since the temperature difference is sufficiently secured, when a heat treatment is performed on the metal powder between a temperature of the first exothermic peak P1 and a temperature of the second exothermic peak P2, an amount of heat necessary for the generation of the above crystal grains is easily applied to the metal powder. Therefore, since the crystallization treatment can be performed at a higher temperature, it is possible to appropriately grow crystal grains while avoiding the generation of the unnecessary crystal structure. As a result, the soft magnetic powder whose crystallite diameter is controlled within the above range can be easily produced.

The temperature difference Tx2−Tx1 between the first exothermic peak P1 and the second exothermic peak P2 is preferably 130° C. or higher and 165° C. or lower, and more preferably 135° C. or higher and 155° C. or lower.

When the temperature difference goes below the above lower limit value, the crystallization corresponding to the second exothermic peak P2 occurs unintentionally when a sufficient amount of crystal grains within the above range of the crystallite diameter are generated, that is, when the heat treatment is performed at a temperature sufficiently higher than the temperature of the first exothermic peak P1. On the other hand, the temperature difference may exceed the above upper limit value, and depending on the temperature of the second exothermic peak P2, the temperature of the first exothermic peak P1 becomes too low. In this case, the grain diameter of the crystal grains tends to vary, and the crystallite diameter of the generated crystal grains tends to be out of the above range.

The temperature difference is influenced by the composition of the metal powder, particularly the content of Cr. As shown in FIG. 1, when the content of Cr changes from 0 atomic % to 2.0 atomic %, the temperature difference tends to increase accordingly. In addition, it is considered that the state of the amorphous structure in the metal powder is also influenced, and for example, when a cooling rate during the formation of the amorphous structure is low, the temperature difference tends to be narrow. Therefore, when the metal powder is to be produced, a production method in which the cooling rate from the molten metal is high, for example, the rotary water atomization method is preferably used among the atomization methods.

The metal powder as described above is subjected to a crystallization treatment (heat treatment). Accordingly, at least a part of the amorphous structure is crystallized to form the crystal grains.

The crystallization treatment can be performed by subjecting a soft magnetic powder having an amorphous structure to a heat treatment. A temperature in the heat treatment is not particularly limited, and is preferably 520° C. or higher and 640° C. or lower, more preferably 530° C. or higher and 630° C. or lower, and still more preferably 540° C. or higher and 620° C. or lower. In addition, as for a time in the heat treatment, a time during which the above temperature is maintained is preferably 1 minute or longer and 180 minutes or shorter, more preferably 3 minutes or longer and 120 minutes or shorter, and still more preferably 5 minutes or longer and 60 minutes or shorter. By setting the temperature and the time in the heat treatment to be within the above ranges, crystal grains having a more appropriate and uniform crystallite diameter can be generated.

When the temperature or the time in the heat treatment goes below the above lower limit value, depending on the composition or the like of the soft magnetic powder, the crystallization may be insufficient, the crystallite diameter may become too small, and the uniformity of the crystallite diameters may be deteriorated. On the other hand, when the temperature or the time in the heat treatment exceeds the above upper limit value, depending on the composition or the like of the soft magnetic powder, the crystallization may excessively proceed, the crystallite diameter may become too large, and the uniformity of the crystallite diameters may be deteriorated.

An atmosphere in the crystallization treatment is not particularly limited, and is preferably an inert gas atmosphere such as nitrogen or argon, a reducing gas atmosphere such as hydrogen or ammonia decomposition gas, or a reduced-pressure atmosphere thereof. Accordingly, it is possible to crystallize the metal while preventing oxidation of the metal, and it is possible to obtain a soft magnetic powder having excellent magnetic properties.

The oxygen concentration in the atmosphere in the crystallization treatment influences a produced amount of oxides. Therefore, the oxygen concentration in the atmosphere in the crystallization treatment is preferably 1000 ppm or less, more preferably 5 ppm or more and 500 ppm or less, and still more preferably 10 ppm or more and 200 ppm or less in terms of volume ratio. Accordingly, the generation of oxides can be prevented, and a soft magnetic powder with which a high-density green compact can be produced can be obtained.

A temperature drop rate in the crystallization treatment is preferably 1° C./min or more and 100° C./min or less, more preferably 2° C./min or more and 30° C./min or less, and still more preferably 4° C./min or more and 20° C./min or less. By setting the temperature drop rate within the above range, it becomes easier to control the crystallite diameter of the soft magnetic powder within the above range. In addition, a variation in crystallite diameter can be prevented. When the temperature drop rate goes below the above lower limit value, the crystallite diameter of the soft magnetic powder is likely to be too large, and on the other hand, when the temperature drop rate exceeds the above upper limit value, the variation in crystallite diameter of the soft magnetic powder may increase.

In this way, the soft magnetic powder according to the embodiment can be produced.

The produced soft magnetic powder may be classified as necessary. Examples of a classification method include dry classification such as sieving classification, inertial classification, and centrifugal classification, and wet classification such as sedimentation classification.

An insulating film may be formed at each particle surface of the obtained soft magnetic powder as necessary. Examples of a constituent material of the insulating film include inorganic materials such as phosphates such as magnesium phosphate, calcium phosphate, zinc phosphate, manganese phosphate, and cadmium phosphate, and silicates such as sodium silicate, ceramic materials such as silica, alumina, magnesia, zirconia, and titania, and glass materials such as borosilicate glass and silica glass.

### 2.2. Effects of Metal Powder According to Embodiment

As described above, the metal powder according to the embodiment is a metal powder crystallized by being subjected to a heat treatment, and contains a composition represented by a composition formula FeₓCuₐNb_{b} (Si_{1-y}(B_{1-z}Cr_{z})_{y})_{100-x-a-b} in terms of
atomic ratio,
[in which a, b, x, y, and z satisfy
0.3≤a≤2.0,
2.0≤b≤4.0,
75.5≤x≤79.5,
0.55≤y≤0.91, and
0.015≤z≤0.185], and impurities, in which
a DSC curve obtained by differential scanning calorimetry has a first exothermic peak and a second exothermic peak located on a higher temperature side than the first exothermic peak, and a temperature difference between the first exothermic peak and the second exothermic peak is 125° C. or higher and 180° C. or lower.

According to such a configuration, since a crystallization treatment can be performed at a higher temperature, it is possible to obtain a metal powder in which crystal grains can be appropriately grown while avoiding generation of an unnecessary crystal structure. Accordingly, it is possible to obtain a metal powder with which a soft magnetic powder in which the crystallite diameter is controlled within an optimum range can be produced.

### 3. Dust Core and Magnetic Element

Next, the dust core and the magnetic element according to the embodiment will be described.

The magnetic element according to the embodiment can be applied to various magnetic elements that include a magnetic core, such as a choke coil, an inductor, a noise filter, a reactor, a transformer, a motor, an actuator, an electromagnetic valve, and a generator. The dust core according to the embodiment can be applied to a magnetic core in these magnetic elements.

Hereinafter, two types of coil components will be representatively described as examples of the magnetic element.

### 3.1. Toroidal Type

First, a toroidal type coil component that is an example of the magnetic element according to the embodiment will be described.

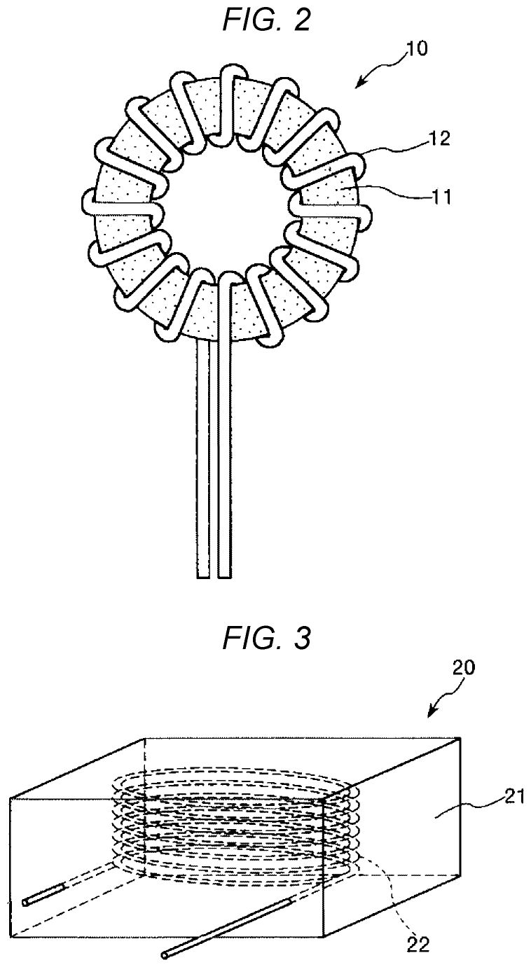

FIG. 2 is a plan view schematically showing a toroidal type coil component 10.

The coil component 10 shown in FIG. 2 includes a ring-shaped dust core 11 and a conductive wire 12 wound around the dust core 11.

The dust core 11 is obtained by mixing the soft magnetic powder according to the embodiment and a binder, supplying the obtained mixture to a mold, and pressing and molding the mixture. That is, the dust core 11 is a green compact containing the soft magnetic powder according to the embodiment. Such a dust core 11 has a high molding density and a high magnetic permeability. Therefore, when the dust core 11 is mounted on an electronic device or the like, it is possible to achieve high performance and a small size of the electronic device or the like. The binder may be added as necessary, or may be omitted.

The coil component 10 as a magnetic element including such a dust core 11 has a high magnetic permeability.

Examples of a constituent material of the binder used for preparing the dust core 11 include organic materials such as silicone-based resins, epoxy-based resins, phenol-based resins, polyamide-based resins, polyimide-based resins, and polyphenylene sulfide-based resins, and inorganic materials such as phosphates such as magnesium phosphate, calcium phosphate, zinc phosphate, manganese phosphate, and cadmium phosphate, and silicates such as sodium silicate. In particular, the constituent material of the binder is preferably a thermosetting polyimide or an epoxy-based resin. The resin materials are easily cured by being heated and have excellent heat resistance. Therefore, ease of producing the dust core 11 and heat resistance thereof can be improved.

A ratio of the binder with respect to the soft magnetic powder slightly varies depending on a target saturation magnetic flux density and mechanical properties of the dust core 11 to be prepared, an acceptable eddy current loss, or the like, and is preferably about 0.5 mass % or more and 5 mass % or less, and more preferably about 1 mass % or more and 3 mass % or less. Accordingly, it is possible to obtain the dust core 11 having excellent magnetic properties such as the saturation magnetic flux density and the magnetic permeability while sufficiently binding the particles of the soft magnetic powder to each other. Various additives may be added to the mixture as necessary for any purpose.

Examples of a constituent material of the conductive wire 12 include a material having high conductivity, for example, a metal material including Cu, Al, Ag, Au, and Ni. An insulating film is provided as necessary at a surface of the conductive wire 12.

A shape of the dust core 11 is not limited to a ring shape shown in FIG. 2, and may be, for example, a shape in which a part of the ring is missing, or a shape in which a shape in a longitudinal direction is linear.

The dust core 11 may contain, as necessary, a soft magnetic powder other than the above soft magnetic powder according to the embodiment, or a non-magnetic powder.

### 3.2. Closed Magnetic Circuit Type

Next, a closed magnetic circuit type coil component that is an example of the magnetic element according to the embodiment will be described.

FIG. 3 is a transparent perspective view schematically showing a closed magnetic circuit type coil component 20.

Hereinafter, the closed magnetic circuit type coil component 20 will be described. In the following description, differences from the toroidal type coil component 10 will be mainly described, and description of similar matters is omitted.

As shown in FIG. 3, the coil component 20 according to the embodiment is formed by embedding a conductive wire 22 formed in a coil shape inside a dust core 21. That is, the coil component 20 is formed by molding the conductive wire 22 with the dust core 21. The dust core 21 has a configuration similar to that of the above dust core 11.

The coil component 20 in such a form can be easily obtained with a relatively small size. Then, the coil component 20 having a small size and a high magnetic permeability is obtained.

In addition, since the conductive wire 22 is embedded in the dust core 21, a gap is less likely to be formed between the conductive wire 22 and the dust core 21. Therefore, vibration caused by magnetostriction of the dust core 21 can be prevented, and generation of noise due to the vibration can also be prevented.

The dust core 21 may contain, as necessary, a soft magnetic powder other than the above soft magnetic powder according to the embodiment or a non-magnetic powder.

### 4. Electronic Device

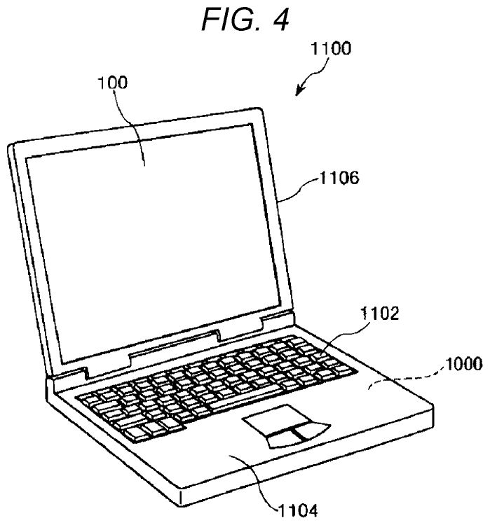

Next, an electronic device including the magnetic element according to the embodiment will be described with reference to FIGS. 4 to 6.

FIG. 4 is a perspective view showing a configuration of a mobile personal computer 1100 which is an electronic device including the magnetic element according to the embodiment. The personal computer 1100 shown in FIG. 4 includes a main body 1104 including a keyboard 1102 and a display unit 1106 including a display 100. The display unit 1106 is rotatably supported by the main body 1104 via a hinge structure. Such a personal computer 1100 is embedded with a magnetic element 1000 such as a choke coil or an inductor for a switching power supply, or a motor.

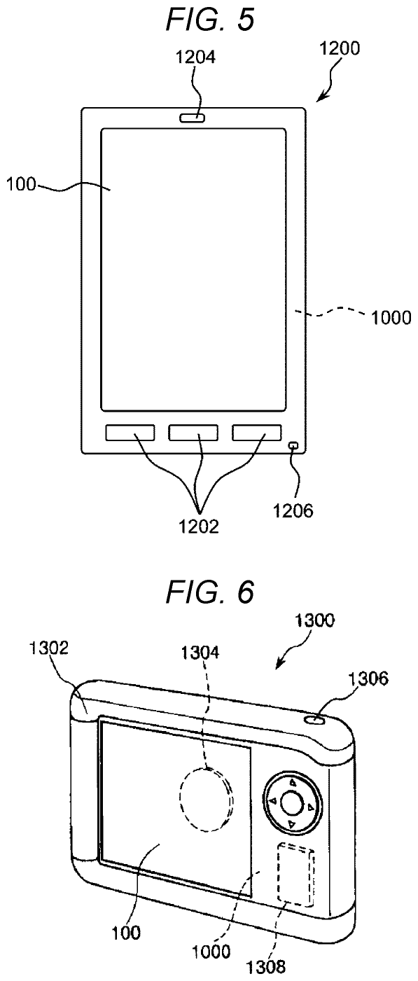

FIG. 5 is a plan view showing a configuration of a smartphone 1200 which is an electronic device including the magnetic element according to the embodiment. The smartphone 1200 shown in FIG. 5 includes a plurality of operation buttons 1202, an earpiece 1204, and a mouthpiece 1206. The display 100 is disposed between the operation buttons 1202 and the earpiece 1204. Such a smartphone 1200 is embedded with the magnetic element 1000 such as an inductor, a noise filter, and a motor.

FIG. 6 is a perspective view showing a configuration of a digital still camera 1300 which is an electronic device including the magnetic element according to the embodiment. The digital still camera 1300 photoelectrically converts an optical image of a subject by an imaging element such as a charge coupled device (CCD) so as to generate an imaging signal.

The digital still camera 1300 shown in FIG. 6 includes the display 100 provided at a rear surface of a case 1302. The display 100 functions as a finder which displays the subject as an electronic image. A light receiving unit 1304 including an optical lens, CCD, or the like is provided at a front surface side of the case 1302, that is, at a rear surface side in the drawing.

When a photographer confirms a subject image displayed on the display 100 and presses a shutter button 1306, an imaging signal of CCD at this time is transferred to and stored in a memory 1308. Such a digital still camera 1300 is also embedded with the magnetic element 1000 such as an inductor and a noise filter.

Examples of the electronic device according to the embodiment include, in addition to the personal computer in FIG. 4, the smartphone in FIG. 5, and the digital still camera in FIG. 6, a mobile phone, a tablet terminal, a timepiece, an ink jet discharge device such as an ink jet printer, a laptop personal computer, a television, a video camera, a video tape recorder, a car navigation device, a pager, an electronic notebook, an electronic dictionary, a calculator, an electronic game device, a word processor, a workstation, a videophone, a crime prevention television monitor, electronic binoculars, a POS terminal, a medical device (such as an electronic thermometer, a blood pressure meter, a blood glucose meter, an electrocardiogram measuring device, an ultrasonic diagnostic device, or an electronic endoscope), a fish finder, various measuring devices, instruments for a vehicle, an aircraft, and a ship, a movable body control device (such as an automobile control device, an aircraft control device, a railway vehicle control device, or a ship control device), and a flight simulator.

Such an electronic device includes the magnetic element according to the embodiment. Accordingly, effects of the magnetic element of a high magnetic permeability can be obtained, and the output of the electronic device can be increased and the size of the electronic device can be reduced.

The soft magnetic powder, the metal powder, the dust core, the magnetic element, and the electronic device according to the present disclosure are described above based on the preferred embodiment, but the present disclosure is not limited thereto.

For example, although a green compact such as a dust core is described as an application example of the soft magnetic powder according to the present disclosure in the above embodiment, the application example is not limited thereto, and a magnetic fluid or a magnetic device such as a magnetic head may also be used. The shapes of the dust core and the magnetic element are not limited to those shown in the drawings, and may be any shape.

### EXAMPLES

Next, specific examples of the present disclosure will be described.

### 5. Production of Molded Body

### 5.1. Sample No. 1

First, a raw material was melted in a high-frequency induction furnace and pulverized by a rotary water atomization method to obtain a metal powder.

Next, the obtained metal powder was subjected to a crystallization treatment that heats the metal powder in a nitrogen atmosphere. Heating temperatures in the heat treatment are as shown in Table 1. The temperature drop rate after heating was 10° C./min. The heating temperature shown in Table 1 is a value obtained by searching in advance for a heating temperature at which the coercive force of the soft magnetic powder is minimized.

Next, classification was performed by an air classifier. A composition of the obtained soft magnetic powder is shown in Table 1.

Next, the particle size distribution of the obtained soft magnetic powder was measured. Then, the average particle diameter of the soft magnetic powder was obtained based on the particle size distribution and was 20 μm.

Next, the obtained soft magnetic powder and an epoxy resin as a binder were mixed to obtain a mixture. An addition amount of the epoxy resin was 2 parts by mass with respect to 100 parts by mass of the soft magnetic powder (2 mass % of the soft magnetic powder).

Next, the obtained mixture was stirred and then dried for a short time, to obtain a massive dried body. Next, the dried body was sieved with a sieve having an opening of 600 μm, and the dried body was pulverized, to obtain a granulated powder. The obtained granulated powder was dried at 50° C. for 1 hour.

Next, a mold was filled with the obtained granulated powder, molding was performed under the following molding conditions, and the binder was cured under the following curing conditions to obtain a molded body.

Molding Conditions
Molding method: press molding
Shape of molded body: ring shape
Dimensions of molded body: outer diameter 14 mm, inner diameter 8 mm, thickness 3 mm
Molding pressure: 3 t/cm² (294 MPa)

Curing Conditions for Binder
Heating temperature: 150° C.
Heating time: 0.5 hour
Heating atmosphere: air atmosphere

### 5.2. Sample Nos. 2 to 15

Molded bodies were obtained in the same manner as in the sample No. 1 except that production conditions of the soft magnetic powder and heat treatment conditions were changed as shown in Table 1.

TABLE 1

| | | | Composition of soft magnetic | | | | | | | | | Structure | | | | Heat |
|---|---|---|---|---|---|---|---|---|---|---|---|---|---|---|---|---|
| | | | powder and metal powder | | | | | | | | | of | Crystallization | | | treat- |
| | | | | | | | | | | (B + Cr)/ | Cr/ | metal | temperature of | | | ment |
| | | | | | | | | | | (Si + | (B + | powder | metal powder | | | Heating |
| | Example/ | | Fe | Cu | Nb | | | | | B + Cr) | Cr) | before | | | Tx2- | temper- |
| Sample | Comparative | Atomization | x | a | b | Si | B | Cr | Total | y | z | heat | Tx1 | Tx2 | Tx1 | ature |
| No. | Example | method | Atomic % | | | | | | | — | — | treatment | ° C. | ° C. | ° C. | ° C. |
| No. 1 | Comparative | Rotary water | 70.7 | 0.8 | 5.0 | 15.0 | 8.0 | 0.5 | 100.0 | 0.36 | 0.059 | Amorphous | 470 | 590 | 120 | 580 |
| | Example | | | | | | | | | | | | | | | |
| No. 2 | Example | Rotary water | 76.0 | 1.0 | 13.0 | 8.0 | 10.8 | 1.2 | 100.0 | 0.60 | 0.100 | Amorphous | 490 | 620 | 130 | 610 |
| No. 3 | Comparative | Rotary water | 77.0 | 1.0 | 3.0 | 5.7 | 13.2 | 0.1 | 100.0 | 0.70 | 0.008 | Amorphous | 499 | 619 | 120 | 570 |
| | Example | | | | | | | | | | | | | | | |
| No. 4 | Example | Rotary water | 77.0 | 1.0 | 3.0 | 5.7 | 13.0 | 0.3 | 100.0 | 0.70 | 0.023 | Amorphous | 494 | 621 | 127 | 580 |
| No. 5 | Example | Rotary water | 77.0 | 1.0 | 3.0 | 5.7 | 12.8 | 0.5 | 100.0 | 0.70 | 0.038 | Amorphous | 491 | 622 | 131 | 590 |
| No. 6 | Example | Rotary water | 77.0 | 1.0 | 3.0 | 5.7 | 12.3 | 1.0 | 100.0 | 0.70 | 0.075 | Amorphous | 486 | 626 | 140 | 600 |
| No. 7 | Example | Rotary water | 77.0 | 1.0 | 3.0 | 5.7 | 11.8 | 1.5 | 100.0 | 0.70 | 0.113 | Amorphous | 487 | 627 | 140 | 610 |
| No. 8 | Example | Rotary water | 77.0 | 1.0 | 3.0 | 5.7 | 11.3 | 2.0 | 100.0 | 0.70 | 0.150 | Amorphous | 474 | 636 | 162 | 600 |
| No. 9 | Example | Rotary water | 77.0 | 1.0 | 3.0 | 5.7 | 10.9 | 2.4 | 100.0 | 0.70 | 0.180 | Amorphous | 468 | 642 | 174 | 590 |
| No. 10 | Comparative | Rotary water | 77.0 | 1.0 | 3.0 | 5.7 | 10.3 | 3.0 | 100.0 | 0.70 | 0.226 | Amorphous | 463 | 648 | 185 | 570 |
| | Example | | | | | | | | | | | | | | | |
| No. 11 | Comparative | Rotary water | 77.0 | 1.0 | 3.0 | 1.5 | 16.5 | 1.0 | 100.0 | 0.92 | 0.057 | Amorphous | 460 | 640 | 180 | 570 |
| | Example | | | | | | | | | | | | | | | |
| No. 12 | Example | Rotary water | 78.0 | 1.2 | 2.7 | 4.5 | 12.1 | 1.5 | 100.0 | 0.75 | 0.110 | Amorphous | 490 | 628 | 138 | 610 |
| No. 13 | Example | Rotary water | 78.0 | 1.0 | 3.0 | 1.8 | 14.7 | 1.5 | 100.0 | 0.90 | 0.093 | Amorphous | 491 | 618 | 127 | 610 |
| No. 14 | Example | Rotary water | 79.0 | 0.8 | 3.5 | 1.7 | 13.8 | 1.2 | 100.0 | 0.90 | 0.080 | Amorphous | 493 | 623 | 130 | 600 |
| No. 15 | Comparative | Rotary water | 80.0 | 1.0 | 3.0 | 1.6 | 13.4 | 1.0 | 100.0 | 0.90 | 0.069 | Crystalline | — | — | — | 600 |
| | Example | | | | | | | | | | | | | | | |

In Table 1, among the metal powders and the soft magnetic powders of the respective sample Nos., powders corresponding to the present disclosure are shown as “Examples”, and powders not corresponding to the present disclosure are shown as “Comparative Examples”.

6. Evaluation of Metal powder, Soft Magnetic Powder, and Molded Body (Dust Core)

### 6.1. Crystallization Temperature of Metal Powder

The metal powder of each of Examples and Comparative Examples was subjected to the differential scanning calorimetry (DSC), and the temperature Tx1 at the peak top of the first exothermic peak and the temperature Tx2 at the peak top of the second exothermic peak were obtained from the acquired DSC curve as crystallization temperatures. The obtained crystallization temperatures and a temperature difference Tx2−Tx1 are shown in Table 1.

### 6.2. Crystallite Diameter of Soft Magnetic Powder

The crystallite diameter of the soft magnetic powder of each of Examples and Comparative Examples was measured by the X-ray diffractometry. Measurement results are shown in Table 2.

### 6.3. Content of Oxygen in Soft Magnetic Powder

The content of oxygen in the soft magnetic powder of each of Examples and Comparative Examples was measured. The content of oxygen was measured using an oxygen/nitrogen/hydrogen elemental analyzer ONH836 manufactured by LECO Corporation. Measurement results are shown in Table 2.

### 6.4. Density of Molded Body

The density of the molded body produced by using the soft magnetic powder of each of Examples and Comparative Examples was measured. Then, the measured density of the molded body was evaluated in light of the following evaluation criteria. Measurement results are shown in Table 2.
A: The density of the molded body is 5.01 g/cm³ or more.
B: The density of the molded body is 4.99 g/cm³ or more and less than 5.01 g/cm³.
C: The density of the molded body is less than 4.99 g/cm³.

### 6.5. Coercive Force of Soft Magnetic Powder

The coercive force of the soft magnetic powder of each of Examples and Comparative Examples was measured. The measured coercive force was evaluated in light of the following evaluation criteria. Evaluation results are shown in Table 2.
A: The coercive force is less than 0.90 Oe.
B: The coercive force is 0.90 Oe or more and less than 1.33 Oe.
C: The coercive force is 1.33 Oe or more and less than 1.67 Oe.
D: The coercive force is 1.67 Oe or more and less than 2.00 Oe.
E: The coercive force is 2.00 Oe or more and less than 2.33 Oe.
F: The coercive force is 2.33 Oe or more.

### 6.6. Saturation Magnetic Flux Density of Soft Magnetic Powder

The saturation magnetic flux density of each of the soft magnetic powders obtained in Examples and Comparative Examples was calculated. Calculation results are shown in Table 2.

### 6.7. Magnetic Permeability of Molded Body

The magnetic permeability of the molded body produced by using the soft magnetic powder obtained in each of Examples and Comparative Examples was measured. Measurement results are shown in Table 2.

In Table 2, among soft magnetic powders and molded bodies of the respective sample Nos., soft magnetic powders and molded bodies corresponding to the present disclosure are shown as “Examples”, and soft magnetic powders and molded bodies not corresponding to the present disclosure are shown as “Comparative Examples”.

TABLE 2

| | | Evaluation result | | Evaluation result of | | | |
|---|---|---|---|---|---|---|---|
| | | of soft | | molded body and the like | | | |
| | | magnetic powder | | Density | | Saturation | |
| | | | Content | of | | magnetic | Magnetic |
| | Example/ | Crystallite | of | molded | Coercive | flux | permeability |
| Sample | Comparative | diameter | oxygen | body | force | density | (1 MHz) |
| No. | Example | nm | ppm | — | — | T | — |
| No. 1 | Comparative Example | 9.5 | 1025 | C | C | 1.05 | 23.4 |
| No. 2 | Example | 9.3 | 630 | A | A | 1.35 | 24.7 |
| No. 3 | Comparative Example | 8.1 | 945 | C | B | 1.32 | 23.6 |
| No. 4 | Example | 8.5 | 860 | B | B | 1.40 | 24.3 |
| No. 5 | Example | 9.2 | 795 | B | B | 1.40 | 24.8 |
| No. 6 | Example | 9.7 | 659 | A | A | 1.40 | 25.0 |
| No. 7 | Example | 10.5 | 584 | A | A | 1.40 | 25.2 |
| No. 8 | Example | 8.2 | 521 | A | B | 1.40 | 24.2 |
| No. 9 | Example | 7.8 | 499 | A | C | 1.40 | 24.0 |
| No. 10 | Comparative Example | 5.5 | 480 | A | E | 1.35 | 23.0 |
| No. 11 | Comparative Example | 4.8 | 400 | A | B | 1.25 | 22.6 |
| No. 12 | Example | 10.3 | 590 | A | A | 1.25 | 25.1 |
| No. 13 | Example | 9.8 | 602 | A | B | 1.42 | 25.0 |
| No. 14 | Example | 9.5 | 623 | A | C | 1.43 | 24.9 |
| No. 15 | Comparative Example | 25.0 | 1650 | C | F | 1.38 | 25.1 |

As is clear from Table 2, in the soft magnetic powder of each Example, even when the content of Fe is high, the oxidation resistance is excellent, and the content of oxygen is reduced to be relatively low. In addition, it is found that the molded body produced using the soft magnetic powder of each of the respective Examples has a high density and a high magnetic permeability.

In addition, it is found that the temperature difference Tx2−Tx1 is sufficiently wide in the metal powder of each Example. Therefore, it can be said that the crystallization treatment at a higher temperature can be performed on the metal powder of each Example, and as a result, it is easy to control the crystallite diameter to be large and to an extent of not being too large while preventing the generation of an unnecessary crystal structure. Therefore, it is found that, by using the metal powder according to the present disclosure, it is possible to prevent an increase in content of oxygen even after the crystallization treatment and to easily produce a soft magnetic powder with which a molded body having a high magnetic permeability can be produced.

When the water atomization method is used instead of the rotary water atomization method, results having the same tendency as described above are also obtained.

What is claimed is:

1. A soft magnetic powder comprising:
a composition represented by a composition formula FeₓCuₐNb_{b}(Si_{1-y}(B_{1-z}Cr_{z})_{y})_{100-x-a-b} in terms of atomic ratio,
a, b, x, y, and z satisfying
0.3≤a≤2.0,
2.0≤b≤4.0,
75.5≤x≤79.5,
0.55≤y≤0.91, and
0.015≤z≤0.185; and
impurities, wherein
a crystallite diameter measured by X-ray diffractometry is 6.0 nm or more and 13.0 nm or less.

2. The soft magnetic powder according to claim 1, wherein
a content of Si is 4.0 atomic % or more and 8.0 atomic % or less,
a content of B is 9.0 atomic % or more and 13.5 atomic % or less, and
a content of Cr is 0.5 atomic % or more and 2.2 atomic % or less.

3. The soft magnetic powder according to claim 1, wherein
the soft magnetic powder is molded into a ring-shaped molded body having an outer diameter of 14 mm, an inner diameter of 8 mm, and a thickness of 3 mm, and
when a magnetic permeability is measured at a measurement frequency of 1 MHz by using a conductive wire having a wire diameter of 0.6 mm wound seven times around the molded body, the magnetic permeability is 24.0 or more.

4. The soft magnetic powder according to claim 1, wherein
a content of oxygen is 1500 ppm or less.

5. The soft magnetic powder according to claim 1, wherein
when a maximum magnetization measured using a vibrating sample magnetometer is Mm [emu/g] and a true density is ρ [g/cm³], a saturation magnetic flux density Bs [T] obtained by 4Π/10000×ρ×Mm=Bs is 1.25 T or more.

6. The soft magnetic powder according to claim 1, wherein
a density of a molded body obtained by mixing the soft magnetic powder with 2 mass % of an epoxy resin and press-molding the obtained mixture at a pressure of 294 MPa is 4.99 g/cm³ or more.

7. A metal powder crystallized by being subjected to a heat treatment, comprising:
a composition represented by a composition formula FeₓCuₐNb_{b}(Si_{1-y}(B_{1-z}Cr_{z})_{y})_{100-x-a-b} in terms of atomic ratio,
a, b, x, y, and z satisfying
0.3≤a≤2.0,
2.0≤b≤4.0,
75.5≤x≤79.5,
0.55≤y≤0.91, and
0.015≤z≤0.185; and
impurities, wherein
a DSC curve obtained by differential scanning calorimetry has a first exothermic peak and a second exothermic peak located on a higher temperature side than the first exothermic peak, and
a temperature difference between the first exothermic peak and the second exothermic peak is 125° C. or higher and 180° C. or lower.

8. A dust core comprising:
the soft magnetic powder according to claim 1.

9. A magnetic element comprising:
the dust core according to claim 8.

10. An electronic device comprising:
the magnetic element according to claim 9.
